(19) United States
(12) Patent Application Publication
(10) Pub. No.: US 2023/0175517 A1
(43) Pub. Date: Jun. 8, 2023

(54) INTEGRALLY GEARED COMPRESSOR

(71) Applicant: MITSUBISHI HEAVY INDUSTRIES COMPRESSOR CORPORATION, Tokyo (JP)

(72) Inventors: Hiroyuki Miyata, Hiroshima-shi (JP); Masahiro Kobayashi, Hiroshima-shi (JP); Naoto Yonemura, Hiroshima-shi (JP); Yuji Futagami, Hiroshima-shi (JP)

(73) Assignee: MITSUBISHI HEAVY INDUSTRIES COMPRESSOR CORPORATION, Tokyo (JP)

(21) Appl. No.: 18/059,623

(22) Filed: Nov. 29, 2022

(30) Foreign Application Priority Data
Dec. 2, 2021 (JP) 2021-196199

(51) Int. Cl. F04D 25/16; F04D 13/02

(52) U.S. Cl. CPC F04D 25/163; F04D 13/028; F05D 2260/4031

(57) ABSTRACT

An integrally geared compressor includes: a drive gear rotated by a motor; an intermediate gear meshing with the drive gear; a first drive side pinion meshing with the drive gear; a first intermediate side pinion meshing with the intermediate gear; a second intermediate side pinion meshing with the intermediate gear at a position away from the drive gear and the first intermediate side pinion; a first compression unit compressing a working fluid by rotation of the first drive side pinion; a second compression unit compressing a working fluid by rotation of the first intermediate side pinion; and a uniaxial multi-stage compressor further compressing the working fluid compressed by at least one of the first compression unit and the second compression unit.

### BACKGROUND OF THE INVENTION

### Field of the Invention

The present disclosure relates to an integrally geared compressor.

Priority is claimed on Japanese Patent Application No. 2021-196199, filed on Dec. 2, 2021, the content of which is incorporated herein by reference.

### Description of Related Art

Disclosed in, for example, Patent Document 1 is a transmission (integrally geared compressor) including a drive small gear (drive gear) driven by a steam turbine, a large gear as an intermediate gear meshing with the drive small gear and a turbo machine rotor (compression unit), and a driven small gear connected to a main compressor in a state of meshing with the drive gear.

[Patent Document 1] Japanese Patent No. 4991789

### SUMMARY OF THE INVENTION

By the way, the number of compression units may be increased in order to improve the output of an integrally geared compressor. However, due to constraints on the installation of a gear for compression unit rotation, it may be necessary to provide a new intermediate gear between the gear and a drive gear or an existing intermediate gear. Accordingly, the space occupied by the integrally geared compressor may increase as the output of the integrally geared compressor is improved.

The present disclosure provides an integrally geared compressor capable of suppressing an increase in occupied space while improving output.

An integrally geared compressor according to the present disclosure includes: a drive gear configured to rotate by rotation of a motor; an intermediate gear meshing with the drive gear; a first drive side pinion meshing with the drive gear at a position away from the intermediate gear; a first intermediate side pinion meshing with the intermediate gear at a position away from the drive gear; a second intermediate side pinion meshing with the intermediate gear at a position away from the drive gear and the first intermediate side pinion; a first compression unit connected to the first drive side pinion and configured to compress a working fluid supplied from an outside by rotation of the first drive side pinion; a second compression unit connected to the first intermediate side pinion and configured to compress a working fluid supplied from an outside by rotation of the first intermediate side pinion; and a uniaxial multi-stage compressor connected to the second intermediate side pinion and configured to further compress the working fluid compressed by at least one of the first compression unit and the second compression unit.

According to the present disclosure, it is possible to provide an integrally geared compressor capable of suppressing an increase in occupied space while improving output.

### BRIEF DESCRIPTION OF THE DRAWINGS

FIG. 1 is a schematic diagram showing a schematic configuration of an integrally geared compressor according to an embodiment of the present disclosure.

FIG. 2 is a partial cross-sectional view taken along line II-II in FIG. 1.

### DETAILED DESCRIPTION OF THE INVENTION

Hereinafter, an integrally geared compressor according to an embodiment of the present disclosure will be described with reference to the drawings.

(Integrally Geared Compressor)

The integrally geared compressor compresses a process gas as a working fluid generated in, for example, a chemical plant. The integrally geared compressor supplies the boosted process gas to reaction equipment provided in the chemical plant.

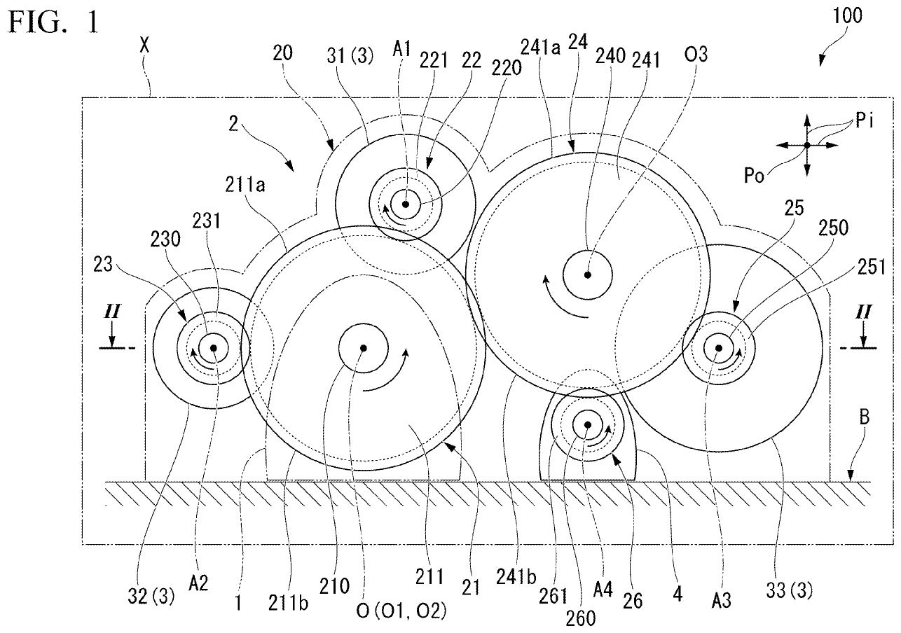

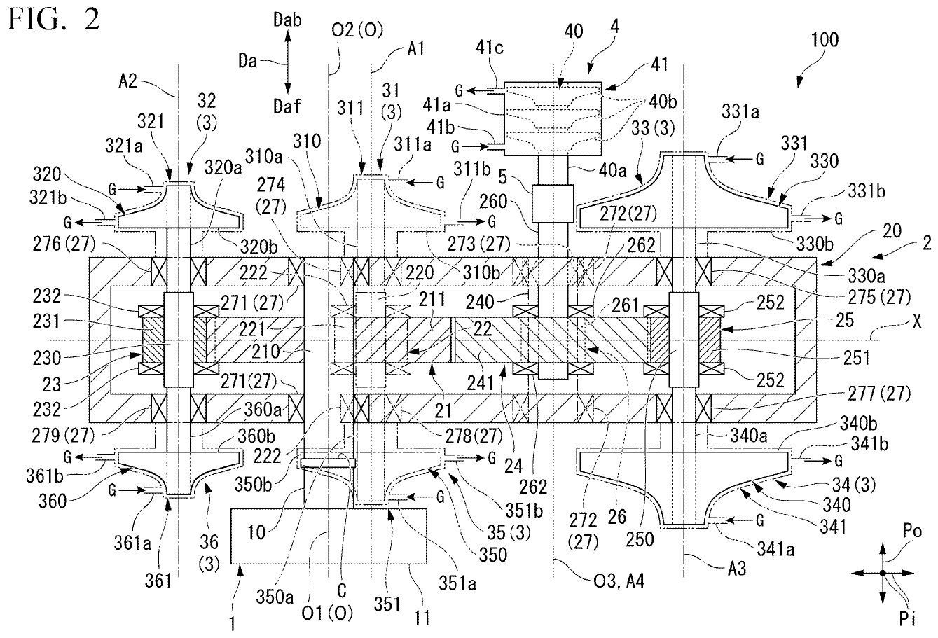

As shown in FIGS. 1 and 2, an integrally geared compressor 100 has a multi-axis multi-stage configuration driving a compression unit 3 having a plurality of impellers. The integrally geared compressor 100 includes a motor 1, a compression unit drive mechanism 2, the compression unit 3, a uniaxial multi-stage compressor 4, and a shaft joint 5.

(Motor)

The motor 1 is a drive source generating power for driving the integrally geared compressor 100. The motor 1 has an output shaft 10 and a motor main body 11 rotating the output shaft 10. The output shaft 10 is a cylindrical drive shaft extending about an output axis O1 extending in the horizontal direction and rotatable around the output axis O1.

The motor main body 11 is fixed in a state of being placed on a foundation B such as the ground, a pedestal, and a base plate. The motor main body 11 has, for example, a motor stator (not shown) as a stator and a motor rotor (not shown) as a rotor integrally fixed to the output shaft 10.

The motor stator is electrically connected to, for example, an external electric power system. By an electric current flowing through a coil of the motor stator, an electromagnetic force rotating the motor rotor in the circumferential direction of the output shaft 10 is generated. In other words, the output shaft 10 rotates when electric power is input from the outside to the motor stator of the motor main body 11.

(Compression Unit Drive Mechanism)

The compression unit drive mechanism 2 rotates an apparatus compressing a working fluid G supplied from the outside by the power (torque) generated by the motor 1 being transmitted. The compression unit drive mechanism 2 has a gear case 20, a drive gear 21, a first drive side pinion 22, a second drive side pinion 23, an intermediate gear 24, a first intermediate side pinion 25, a second intermediate side pinion 26, and a bearing 27.

(Gear Case)

The gear case 20 is a casing for accommodating a plurality of gears inside.

(Drive Gear)

The drive gear 21 is a gear accommodated in the gear case 20 and rotated by the rotation of the motor 1. The drive gear 21 has a drive support shaft 210 and a drive gear main body 211. The drive support shaft 210 has a cylindrical shape extending about a drive axis O2 extending in the horizontal direction.

The drive support shaft 210 in the present embodiment is integrally connected to the output shaft 10 of the motor 1 via a flexible coupling C. Accordingly, the drive support shaft 210 is rotated with the rotation of the output shaft 10.

Here, the output axis O1 on the output shaft 10 and the drive axis O2 on the drive support shaft 210 are on the same straight line. The output shaft 10 and the drive support shaft 210 share an axis O as a center line. The axis O is configured by the output axis O1 and the drive axis O2.

In the present embodiment, the direction in which the axis O extends (up-down direction in FIG. 2) is simply referred to as “axial direction Da”. In addition, one of both sides in the axial direction Da (upper side in FIG. 2, first side) is simply referred to as “one side Dab”, and the opposite side (lower side in FIG. 2, second side) is simply referred to as “the other side Daf”.

The drive gear main body 211 is a helical gear fixed to the drive support shaft 210 from the outer peripheral side and spreading about the drive support shaft 210. The drive gear main body 211 spreads in a direction perpendicular to the axis O. The drive support shaft 210 protrudes from the drive gear main body 211 to the one side Dab and the other side Daf.

Hereinafter, for convenience of description, the direction in which a virtual surface X spreading in the direction perpendicular to the axis O (direction in which the drive gear main body 211 spreads) and bisecting the drive gear 21 in the axial direction Da spreads will be referred to as “in-plane direction Pi”. At this time, the axial direction Da corresponds to “out-of-plane direction Po” with respect to the virtual surface X.

(First Drive Side Pinion)

The first drive side pinion 22 is a gear accommodated in the gear case 20 and rotating with the rotation of the drive gear 21. The first drive side pinion 22 has a first drive side pinion support shaft 220, a first drive side pinion main body 221, and a first thrust bearing 222. The first drive side pinion support shaft 220 has a cylindrical shape extending about a first axis A1 parallel to the axis O.

The first drive side pinion main body 221 is fixed to the first drive side pinion support shaft 220 from the outer peripheral side. The first drive side pinion main body 221 is a helical gear spreading about the first drive side pinion support shaft 220. The first drive side pinion main body 221 spreads in a direction perpendicular to the first axis A1. The first drive side pinion support shaft 220 protrudes from the first drive side pinion main body 221 to the one side Dab and the other side Daf.

The first drive side pinion main body 221 meshes with the drive gear main body 211 in a state of being adjacent to the drive gear main body 211 in the in-plane direction Pi. The first drive side pinion main body 221 in the present embodiment meshes only with a drive gear upper half portion 211a in the drive gear main body 211.

The outer diameter of the first drive side pinion main body 221 in the present embodiment is smaller than the outer diameter of the drive gear main body 211. Accordingly, the number of teeth of the first drive side pinion main body 221 is smaller than the number of teeth of the drive gear main body 211.

The drive gear upper half portion 211a in the drive gear main body 211 in the present embodiment means the drive gear main body 211 in the region above the axis O in the vertical direction (up-down direction in FIG. 1) when the drive gear main body 211 is viewed from the axial direction Da.

In addition, a drive gear lower half portion 211b in the drive gear main body 211 means the drive gear main body 211 in the region below the axis O in the vertical direction when the drive gear main body 211 is viewed from the axial direction Da.

In addition, the tooth bottom circle diameter, the tooth tip circle diameter, the pitch circle diameter, or the like that can be measured as the distance (dimension) from the central axis of each gear is adopted as “outer diameter” of the gear in the present embodiment.

The first thrust bearing 222 is a pair of thrust bearings fixed so as to surround the first drive side pinion support shaft 220 of the first drive side pinion 22 from the outer peripheral side. The first thrust bearing 222 is disposed closer to each of the one side Dab and the other side Daf than the first drive side pinion main body 221 of the first drive side pinion 22.

The first thrust bearing 222 is formed larger in diameter than the first drive side pinion main body 221. The first thrust bearing 222 comes into sliding contact from the axial direction Da with, for example, a thrust collar (not shown) spreading in a disk shape from the first drive side pinion support shaft 220 toward the outer peripheral side integrally with the first drive side pinion support shaft 220. As a result, displacement of the first drive side pinion main body 221 in the axial direction Da is regulated.

(Second Drive Side Pinion)

The second drive side pinion 23 is a gear accommodated in the gear case 20 and rotating with the rotation of the drive gear 21. The second drive side pinion 23 has a second drive side pinion support shaft 230, a second drive side pinion main body 231, and a second thrust bearing 232. The second drive side pinion support shaft 230 has a cylindrical shape extending about a second axis A2 parallel to the axis O.

The second drive side pinion main body 231 is a helical gear spreading about the second drive side pinion support shaft 230. The second drive side pinion main body 231 spreads in a direction perpendicular to the second axis A2. The second drive side pinion support shaft 230 protrudes from the second drive side pinion main body 231 to the one side Dab and the other side Daf.

The second drive side pinion main body 231 meshes with the drive gear main body 211 at a position separated in the in-plane direction Pi from the first drive side pinion main body 221 of the first drive side pinion 22. The second drive side pinion main body 231 is adjacent to the drive gear main body 211 in the in-plane direction Pi. The second drive side pinion main body 231 in the present embodiment meshes only with the part of the drive gear main body 211 where the drive gear upper half portion 211a and the drive gear lower half portion 211b are switched.

The outer diameter of the second drive side pinion main body 231 in the present embodiment is equal to the outer diameter of the first drive side pinion main body 221 of the first drive side pinion 22. Accordingly, the number of teeth of the second drive side pinion main body 231 is equal to the number of teeth of the first drive side pinion main body 221 of the first drive side pinion 22.

The second thrust bearing 232 is a pair of thrust bearings fixed so as to surround the second drive side pinion support shaft 230 of the second drive side pinion 23 from the outer peripheral side. The second thrust bearing 232 is disposed on each of the one side Dab and the other side Daf with respect to the second drive side pinion main body 231 of the second drive side pinion 23.

The second thrust bearing 232 is formed larger in diameter than the second drive side pinion main body 231. The second thrust bearing 232 comes into sliding contact with, for example, a thrust collar (not shown) from the axial direction Da. The thrust collar spreads in a disk shape from the second drive side pinion support shaft 230 toward the outer peripheral side integrally with the second drive side pinion support shaft 230. As a result, displacement of the second drive side pinion main body 231 in the axial direction Da is regulated.

(Intermediate Gear)

The intermediate gear 24 is a gear accommodated in the gear case 20 and rotating with the rotation of the drive gear 21. The intermediate gear 24 has an intermediate support shaft 240 and an intermediate gear main body 241. The intermediate support shaft 240 has a cylindrical shape extending about an intermediate axis O3 parallel to the axis O.

The intermediate gear main body 241 is a helical gear fixed to the intermediate support shaft 240 from the outer peripheral side and spreading about the intermediate support shaft 240. The intermediate gear main body 241 spreads in a direction perpendicular to the intermediate axis O3. The intermediate support shaft 240 protrudes from the intermediate gear main body 241 to the one side Dab and the other side Daf.

The intermediate gear main body 241 meshes with the drive gear main body 211 at a position separated in the in-plane direction Pi from the first drive side pinion main body 221 of the first drive side pinion 22 and the second drive side pinion main body 231 of the second drive side pinion 23. The intermediate gear main body 241 is adjacent to the drive gear main body 211 in the in-plane direction Pi.

As shown in FIG. 1, the intermediate gear main body 241 in the present embodiment meshes with the drive gear upper half portion 211a in the drive gear main body 211. Accordingly, the intermediate axis O3 is positioned above the axis O in the vertical direction.

(First Intermediate Side Pinion)

The first intermediate side pinion 25 is a gear accommodated in the gear case 20 and rotating with the rotation of the intermediate gear 24. The first intermediate side pinion 25 has a first intermediate side pinion support shaft 250, a first intermediate side pinion main body 251, and a third thrust bearing 252. The first intermediate side pinion support shaft 250 has a cylindrical shape extending about a third axis A3 parallel to the axis O.

The first intermediate side pinion main body 251 is fixed to the first intermediate side pinion support shaft 250 from the outer peripheral side. The first intermediate side pinion main body 251 is a helical gear spreading about the first intermediate side pinion support shaft 250. The first intermediate side pinion main body 251 spreads in a direction perpendicular to the third axis A3. The first intermediate side pinion support shaft 250 protrudes from the first intermediate side pinion main body 251 to the one side Dab and the other side Daf.

The first intermediate side pinion main body 251 meshes with the intermediate gear main body 241 in a state of being adjacent to the intermediate gear main body 241 in the in-plane direction Pi. The first intermediate side pinion main body 251 in the present embodiment meshes only with an intermediate gear upper half portion 241a in the intermediate gear main body 241.

The intermediate gear upper half portion 241a in the intermediate gear main body 241 in the present embodiment means the intermediate gear main body 241 in the region above the intermediate axis O3 in the vertical direction when the intermediate gear main body 241 is viewed from the axial direction Da.

In addition, an intermediate gear lower half portion 241b in the intermediate gear main body 241 means the intermediate gear main body 241 in the region below the intermediate axis O3 in the vertical direction when the intermediate gear main body 241 is viewed from the axial direction Da.

The outer diameter of the first intermediate side pinion main body 251 in the present embodiment is equal to the outer diameter of the first drive side pinion main body 221 of the first drive side pinion 22. Accordingly, the number of teeth of the first intermediate side pinion main body 251 is equal to the number of teeth of the first drive side pinion main body 221 of the first drive side pinion 22.

The third thrust bearing 252 is a pair of thrust bearings fixed so as to surround the first intermediate side pinion support shaft 250 of the first intermediate side pinion 25 from the outer peripheral side. The third thrust bearing 252 is disposed closer to the one side Dab and the other side Daf than the first intermediate side pinion main body 251 of the first intermediate side pinion 25.

The third thrust bearing 252 is formed larger in diameter than the first intermediate side pinion main body 251. The third thrust bearing 252 comes into sliding contact with, for example, a thrust collar (not shown) from the axial direction Da. The thrust collar spreads in a disk shape from the first intermediate side pinion support shaft 250 toward the outer peripheral side integrally with the first intermediate side pinion support shaft 250. As a result, displacement of the first intermediate side pinion main body 251 in the axial direction Da is regulated.

(Second Intermediate Side Pinion)

The second intermediate side pinion 26 is a gear accommodated in the gear case 20 and rotating with the rotation of the drive gear 21. The second intermediate side pinion 26 has a second intermediate side pinion support shaft 260, a second intermediate side pinion main body 261, and a fourth thrust bearing 262. The second intermediate side pinion support shaft 260 has a cylindrical shape extending about a fourth axis A4 parallel to the axis O.

The second intermediate side pinion main body 261 is fixed to the second intermediate side pinion support shaft 260 from the outer peripheral side. The second intermediate side pinion main body 261 is a helical gear spreading about the second intermediate side pinion support shaft 260. The second intermediate side pinion main body 261 spreads in a direction perpendicular to the fourth axis A4. The second intermediate side pinion support shaft 260 protrudes from the second intermediate side pinion main body 261 to the one side Dab and the other side Daf.

The second intermediate side pinion main body 261 meshes with the intermediate gear main body 241 at a position separated in the in-plane direction Pi from the first intermediate side pinion main body 251 of the first intermediate side pinion 25. The second intermediate side pinion main body 261 is adjacent to the intermediate gear main body 241 in the in-plane direction Pi.

The second intermediate side pinion main body 261 in the present embodiment meshes only with the intermediate gear lower half portion 241b in the intermediate gear main body 241. Specifically, the second intermediate side pinion main body 261 is disposed directly below the intermediate gear main body 241.

The outer diameter of the second intermediate side pinion main body 261 in the present embodiment is equal to the outer diameter of the first drive side pinion main body 221 of the first drive side pinion 22. Accordingly, the number of teeth of the second intermediate side pinion main body 261 is equal to the number of teeth of the first drive side pinion main body 221 of the first drive side pinion 22.

The fourth thrust bearing 262 is a pair of thrust bearings fixed so as to surround the second intermediate side pinion support shaft 260 of the second intermediate side pinion 26 from the outer peripheral side. The fourth thrust bearing 262 is disposed closer to the one side Dab and the other side Daf than the second intermediate side pinion main body 261 of the second intermediate side pinion 26.

The fourth thrust bearing 262 is formed larger in diameter than the second intermediate side pinion main body 261. The fourth thrust bearing 262 comes into sliding contact from the axial direction Da with, for example, a thrust collar (not shown) spreading in a disk shape from the second intermediate side pinion support shaft 260 toward the outer peripheral side integrally with the second intermediate side pinion support shaft 260. As a result, displacement of the second intermediate side pinion main body 261 in the axial direction Da is regulated.

(Compression Unit)

The compression unit 3 compresses the working fluid G supplied from the outside by being rotated by the rotation of each of the first drive side pinion 22, the second drive side pinion 23, and the first intermediate side pinion 25. The compression unit 3 is configured by a first compression unit 31, a second compression unit 32, a third compression unit 33, a fourth compression unit 34, a fifth compression unit 35, and a sixth compression unit 36.

(First Compression Unit)

The first compression unit 31 is connected to the first drive side pinion 22 and compresses the working fluid G by being rotated by the rotation of the first drive side pinion 22. The first compression unit 31 has a first rotor 310 and a first compression unit casing 311. The first rotor 310 has a first rotating shaft 310a and a first impeller 310b.

The first rotating shaft 310a is a cylindrical member extending about the first axis A1 and rotatable around the first axis A1. The first rotating shaft 310a is integrally connected from the one side Dab to the first drive side pinion support shaft 220 of the first drive side pinion 22 and protrudes from the gear case 20 to the one side Dab.

The first impeller 310b is fixed so as to cover the part of the first rotating shaft 310a protruding from the gear case 20 to the one side Dab from the outer peripheral side. The first impeller 310b has a plurality of blades arranged in the circumferential direction of the first rotating shaft 310a when fixed to the first rotating shaft 310a.

The first compression unit casing 311 covers the first impeller 310b from the outer peripheral side and forms a first compression passage inside together with the first impeller 310b. The first compression unit casing 311 in the present embodiment is formed integrally with the gear case 20.

The first compression unit casing 311 has a first gas introduction port 311a for introducing the working fluid G from the outside into the first compression passage and a first gas discharge port 311b for discharging the compressed working fluid G from the first compression passage to the outside. A pipe (not shown) through which the working fluid G flows is connected to the first gas introduction port 311a and the first gas discharge port 311b.

In the present embodiment, a one-stage compression mechanism is configured by the first rotor 310 and the first compression unit casing 311 in the first compression unit 31. The first compression unit 31 has the single first impeller 310b.

(Second Compression Unit)

The second compression unit 32 is connected to the first intermediate side pinion 25 and compresses the working fluid G by being rotated by the rotation of the first intermediate side pinion 25. The second compression unit 32 has a second rotor 320 and a second compression unit casing 321. The second rotor 320 has a second rotating shaft 320a and a second impeller 320b.

The second rotating shaft 320a is a cylindrical member extending about the third axis A3 and rotatable around the third axis A3. The second rotating shaft 320a is integrally connected from the one side Dab to the first intermediate side pinion support shaft 250 of the first intermediate side pinion 25. Accordingly, the second rotating shaft 320a protrudes from the gear case 20 to the one side Dab.

The second impeller 320b is fixed so as to cover the part of the second rotating shaft 320a protruding from the gear case 20 to the one side Dab from the outer peripheral side. The second impeller 320b has a plurality of blades arranged in the circumferential direction of the second rotating shaft 320a when fixed to the second rotating shaft 320a.

The second compression unit casing 321 covers the second impeller 320b and forms a second compression passage inside together with the second impeller 320b. The second compression unit casing 321 in the present embodiment is formed integrally with the gear case 20.

The second compression unit casing 321 has a second gas introduction port 321a for introducing the working fluid G from the outside into the second compression passage and a second gas discharge port 321b for discharging the compressed working fluid G from the second compression passage to the outside. A pipe through which the working fluid G flows is connected to the second gas introduction port 321a and the second gas discharge port 321b.

In the present embodiment, a one-stage compression mechanism is configured by the second rotor 320 and the second compression unit casing 321 in the second compression unit 32. The second compression unit 32 has the single second impeller 320b.

The second compression unit 32 compresses the working fluid G supplied from the outside in a stage ahead of the first compression unit 31. Accordingly, the working fluid G compressed in the second compression passage in the second compression unit 32 is introduced into the first compression passage in the first compression unit 31 through a pipe and further compressed.

The outer diameter of the second impeller 320b of the second rotor 320 in the second compression unit 32 is larger than the outer diameter of the first impeller 310b of the first rotor 310 in the first compression unit 31. In other words, each blade of the first impeller 310b is formed larger than each blade of the second impeller 320b.

(Third Compression Unit)

The third compression unit 33 is connected to the second drive side pinion 23 and compresses the working fluid G by being rotated by the rotation of the second drive side pinion 23. The third compression unit 33 has a third rotor 330 and a third compression unit casing 331. The third rotor 330 has a third rotating shaft 330a and a third impeller 330b.

The third rotating shaft 330a is a cylindrical member extending about the second axis A2 and rotatable around the second axis A2. The third rotating shaft 330a is integrally connected from the one side Dab to the second drive side pinion support shaft 230 of the second drive side pinion 23 and protrudes from the gear case 20 to the one side Dab.

The third impeller 330b is fixed so as to cover the part of the third rotating shaft 330a protruding from the gear case 20 to the one side Dab from the outer peripheral side. The third impeller 330b has a plurality of blades arranged in the circumferential direction of the third rotating shaft 330a when fixed to the third rotating shaft 330a.

The third compression unit casing 331 covers the third impeller 330b and forms a third compression passage inside together with the third impeller 330b. The third compression unit casing 331 in the present embodiment is formed integrally with the gear case 20.

The third compression unit casing 331 has a third gas introduction port 331a for introducing the working fluid G from the outside into the third compression passage and a third gas discharge port 331b for discharging the compressed working fluid G from the third compression passage to the outside. A pipe through which the working fluid G flows is connected to the third gas introduction port 331a and the third gas discharge port 331b.

In the present embodiment, a one-stage compression mechanism is configured by the third rotor 330 and the third compression unit casing 331 in the third compression unit 33. The third compression unit 33 has the single third impeller 330b.

The third compression unit 33 compresses the working fluid G in a stage behind the first compression unit 31. Accordingly, the working fluid G compressed in the first compression passage in the first compression unit 31 is introduced into the third compression passage in the third compression unit 33 through a pipe and further compressed.

The outer diameter of the third impeller 330b of the third rotor 330 in the third compression unit 33 is smaller than the outer diameter of the first impeller 310b of the first rotor 310 in the first compression unit 31. In other words, each blade of the third impeller 330b is formed smaller than each blade of the first impeller 310b.

(Fourth Compression Unit)

The fourth compression unit 34 is connected to the first intermediate side pinion 25 and compresses the working fluid G by being rotated by the rotation of the first intermediate side pinion 25. The fourth compression unit 34 has a fourth rotor 340 and a fourth compression unit casing 341. The fourth rotor 340 has a fourth rotating shaft 340a and a fourth impeller 340b.

The fourth rotating shaft 340a is a cylindrical member extending about the third axis A3 and rotatable around the third axis A3. The fourth rotating shaft 340a is integrally connected from the other side Daf to the first intermediate side pinion support shaft 250 of the first intermediate side pinion 25. Accordingly, the fourth rotating shaft 340a protrudes from the gear case 20 to the other side Daf.

The fourth impeller 340b is fixed so as to cover the part of the fourth rotating shaft 340a protruding from the gear case 20 to the other side Daf from the outer peripheral side. The fourth impeller 340b has a plurality of blades arranged in the circumferential direction of the fourth rotating shaft 340a when fixed to the fourth rotating shaft 340a.

The fourth compression unit casing 341 covers the fourth impeller 340b and forms a fourth compression passage inside together with the fourth impeller 340b. The fourth compression unit casing 341 in the present embodiment is formed integrally with the gear case 20.

The fourth compression unit casing 341 has a fourth gas introduction port 341a for introducing the working fluid G from the outside into the fourth compression passage and a fourth gas discharge port 341b for discharging the compressed working fluid G from the fourth compression passage to the outside. A pipe through which the working fluid G flows is connected to the fourth gas introduction port 341a and the fourth gas discharge port 341b.

In the present embodiment, a one-stage compression mechanism is configured by the fourth rotor 340 and the fourth compression unit casing 341 in the fourth compression unit 34. The fourth compression unit 34 has the single fourth impeller 340b. The fourth compression unit 34 in the present embodiment compresses the working fluid Gin a stage behind the second compression unit 32 and ahead of the first compression unit 31.

Accordingly, the working fluid G compressed in the second compression passage in the second compression unit 32 is introduced into the fourth compression passage in the fourth compression unit 34 through a pipe and further compressed. The working fluid G compressed in the fourth compression passage in the fourth compression unit 34 is introduced into the first compression passage in the first compression unit 31 through a pipe and further compressed.

The outer diameter of the fourth impeller 340b of the fourth rotor 340 in the fourth compression unit 34 is smaller than the outer diameter of the second impeller 320b of the second rotor 320 in the second compression unit 32. In addition, the outer diameter of the fourth impeller 340b is larger than the outer diameter of the first impeller 310b in the first compression unit 31. In other words, each blade of the fourth impeller 340b is formed smaller than each blade of the second impeller 320b. In addition, each blade of the fourth impeller 340b is formed larger than each blade of the first impeller 310b.

(Fifth Compression Unit)

The fifth compression unit 35 is connected to the first drive side pinion 22 and compresses the working fluid G by being rotated by the rotation of the first drive side pinion 22. The fifth compression unit 35 has a fifth rotor 350 and a fifth compression unit casing 351. The fifth rotor 350 has a fifth rotating shaft 350a and a fifth impeller 350b.

The fifth rotating shaft 350a is a cylindrical member extending about the first axis A1 and rotatable around the first axis A1. The fifth rotating shaft 350a is integrally connected from the other side Daf to the first drive side pinion support shaft 220 of the first drive side pinion 22. The fifth rotating shaft 350a protrudes from the gear case 20 to the other side Daf.

The fifth impeller 350b is fixed so as to cover the part of the fifth rotating shaft 350a protruding from the gear case 20 to the other side Daf from the outer peripheral side. The fifth impeller 350b has a plurality of blades arranged in the circumferential direction of the fifth rotating shaft 350a when fixed to the fifth rotating shaft 350a.

The fifth compression unit casing 351 covers the fifth impeller 350b and forms a fifth compression passage inside together with the fifth impeller 350b. The fifth compression unit casing 351 in the present embodiment is formed integrally with the gear case 20.

The fifth compression unit casing 351 has a fifth gas introduction port 351a for introducing the working fluid G from the outside into the fifth compression passage and a fifth gas discharge port 351b for discharging the compressed working fluid G from the fifth compression passage to the outside. A pipe through which the working fluid G flows is connected to the fifth gas introduction port 351a and the fifth gas discharge port 351b.

In the present embodiment, a one-stage compression mechanism is configured by the fifth rotor 350 and the fifth compression unit casing 351 in the fifth compression unit 35. The fifth compression unit 35 has the single fifth impeller 350b. The fifth compression unit 35 in the present embodiment compresses the working fluid Gin a stage behind the first compression unit 31 and ahead of the third compression unit 33.

Accordingly, the working fluid G compressed in the first compression passage in the first compression unit 31 is introduced into the fifth compression passage in the fifth compression unit 35 through a pipe and further compressed. The working fluid G compressed in the fifth compression passage in the fifth compression unit 35 is introduced into the third compression passage in the third compression unit 33 through a pipe and further compressed.

The outer diameter of the fifth impeller 350b of the fifth rotor 350 in the fifth compression unit 35 is smaller than the outer diameter of the first impeller 310b of the first rotor 310 in the first compression unit 31. In addition, the outer diameter of the fifth impeller 350b is larger than the outer diameter of the third impeller 330b in the third compression unit 33. In other words, each blade of the fifth impeller 350b is formed smaller than each blade of the first impeller 310b. In addition, each blade of the fifth impeller 350b is formed larger than each blade of the third impeller 330b.

(Sixth Compression Unit)

The sixth compression unit 36 is connected to the second drive side pinion 23 and compresses the working fluid G by being rotated by the rotation of the second drive side pinion 23. The sixth compression unit 36 has a sixth rotor 360 and a sixth compression unit casing 361. The sixth rotor 360 has a sixth rotating shaft 360a and a sixth impeller 360b.

The sixth rotating shaft 360a is a cylindrical member extending about the second axis A2 and rotatable around the second axis A2. The sixth rotating shaft 360a is integrally connected from the other side Daf to the second drive side pinion support shaft 230 of the second drive side pinion 23. The sixth rotating shaft 360a protrudes from the gear case 20 to the other side Daf.

The sixth impeller 360b is fixed so as to cover the part of the sixth rotating shaft 360a protruding from the gear case 20 to the other side Daf from the outer peripheral side. The sixth impeller 360b has a plurality of blades arranged in the circumferential direction of the sixth rotating shaft 360a when fixed to the sixth rotating shaft 360a.

The sixth compression unit casing 361 covers the sixth impeller 360b and forms a sixth compression passage inside together with the sixth impeller 360b. The sixth compression unit casing 361 in the present embodiment is formed integrally with the gear case 20.

The sixth compression unit casing 361 has a sixth gas introduction port 361a for introducing the working fluid G from the outside into the sixth compression passage and a sixth gas discharge port 361b for discharging the compressed working fluid G from the sixth compression passage to the outside.

In the present embodiment, a one-stage compression mechanism is configured by the sixth rotor 360 and the sixth compression unit casing 361 in the sixth compression unit 36. The sixth compression unit 36 has the single sixth impeller 360b.

The sixth compression unit 36 in the present embodiment compresses the working fluid Gin a stage behind the third compression unit 33. Accordingly, the working fluid G compressed in the third compression passage in the third compression unit 33 is introduced into the sixth compression passage in the sixth compression unit 36 through a pipe and further compressed.

The outer diameter of the sixth impeller 360b of the sixth rotor 360 in the sixth compression unit 36 is smaller than the outer diameter of the third impeller 330b of the third rotor 330 in the third compression unit 33. In other words, each blade of the sixth impeller 360b is formed smaller than each blade of the third impeller 330b.

Accordingly, the working fluid G supplied from the outside to the compression unit 3 is introduced in the order of the second compression unit 32, the fourth compression unit 34, the first compression unit 31, the fifth compression unit 35, the third compression unit 33, and the sixth compression unit 36 and is sequentially compressed (boosted).

In addition, the size of the impeller in each compression unit 3 (first impeller 310b to sixth impeller 360b) decreases in the order of the second compression unit 32, the fourth compression unit 34, the first compression unit 31, the fifth compression unit 35, the third compression unit 33, and the sixth compression unit 36.

(Uniaxial Multi-stage Compressor)

The uniaxial multi-stage compressor 4 performs boosting by further compressing the working fluid G compressed by the compression unit 3. The uniaxial multi-stage compressor 4 in the present embodiment further compresses the working fluid G compressed by the sixth compression unit 36. The uniaxial multi-stage compressor 4 has a compressor rotor 40 and a compressor casing 41.

The compressor rotor 40 is connected to the second intermediate side pinion 26 and is rotated with the rotation of the second intermediate side pinion 26. The compressor rotor 40 has a compressor rotating shaft 40a and a plurality of compressor impellers 40b. The compressor rotating shaft 40a has a cylindrical shape extending about the fourth axis A4.

The plurality of compressor impellers 40b are arranged on the compressor rotating shaft 40a so as to be lined up in the axial direction Da and rotate around the fourth axis A4 integrally with the compressor rotating shaft 40a. Each compressor impeller 40b has a plurality of blades arranged in the circumferential direction of the compressor rotating shaft 40a when fixed to the compressor rotating shaft 40a. The compressor rotor 40 in the present embodiment has three compressor impellers 40b.

The compressor impellers 40b are formed to have the same size. The outer diameter of each compressor impeller 40b is smaller than the outer diameter of the sixth impeller 360b in the sixth compression unit 36. In other words, each blade of each compressor impeller 40b is formed smaller than each blade of the sixth impeller 360b.

The compressor casing 41 forms the outer shell of the uniaxial multi-stage compressor 4. The compressor casing 41 is fixed in a state of being placed on the foundation B such as the ground, a pedestal, and a base plate. The foundation B in the present embodiment is positioned below the drive gear 21 and the intermediate gear 24 in the vertical direction.

The compressor casing 41 has a casing main body 41a, a suction port 41b formed in the casing main body 41a, and a discharge port 41c formed in the casing main body 41a. A pipe through which the working fluid G flows is connected to the suction port 41b and the discharge port 41c.

The casing main body 41a forms a compressor passage compressing the working fluid G inside together with the compressor rotor 40. The working fluid G compressed by the sixth compression unit 36 is suctioned into the casing main body 41a via the suction port 41b after flowing through the pipe.

The working fluid G suctioned into the casing main body 41a is gradually compressed (boosted) by the plurality of compressor impellers 40b in the compressor passage. The working fluid G compressed in the casing main body 41a is discharged to the outside via the discharge port 41c.

The working fluid G compressed by the uniaxial multi-stage compressor 4 is supplied to, for example, reaction equipment provided outside the integrally geared compressor 100. In the present embodiment, a multi-stage (three-stage) compression mechanism is configured by the compressor rotor 40 and the compressor casing 41 of the uniaxial multi-stage compressor 4.

(Shaft Joint)

The shaft joint 5 is a shaft joint connecting the second intermediate side pinion support shaft 260 of the second intermediate side pinion 26 and the compressor rotating shaft 40a of the uniaxial multi-stage compressor 4. The shaft joint 5 in the present embodiment is, for example, a diaphragm shaft joint. By the shaft joint 5 connecting the second intermediate side pinion support shaft 260 and the compressor rotating shaft 40a, the uniaxial multi-stage compressor 4 rotates integrally with the second intermediate side pinion 26.

The shaft joint 5 is flexible. The shaft joint 5 is elastically deformed when the second intermediate side pinion support shaft 260 and the compressor rotating shaft 40a are misaligned during the operation of the integrally geared compressor 100. As a result, the shaft joint 5 suppresses a loss of torque transmitted from the second intermediate side pinion support shaft 260 to the compressor rotating shaft 40a.

(Bearing)

Here, the bearing 27 of the compression unit drive mechanism 2 rotatably supports each of the drive support shaft 210 of the drive gear 21, the intermediate support shaft 240 of the intermediate gear 24, the second intermediate side pinion support shaft 260 in the second intermediate side pinion 26, the first rotating shaft 310a in the first compression unit 31, the second rotating shaft 320a in the second compression unit 32, the third rotating shaft 330a in the third compression unit 33, the fourth rotating shaft 340a in the fourth compression unit 34, the fifth rotating shaft 350a in the fifth compression unit 35, and the sixth rotating shaft 360a in the sixth compression unit 36.

The bearing 27 is configured by a drive gear bearing 271, an intermediate gear bearing 272, a pinion support shaft bearing 273, a first compression unit bearing 274, a second compression unit bearing 275, a third compression unit bearing 276, a fourth compression unit bearing 277, a fifth compression unit bearing 278, and a sixth compression unit bearing 279.

A pair of the drive gear bearings 271 are fixed to the gear case 20. The drive gear bearing 271 is a radial bearing rotatably supporting the drive support shaft 210 of the drive gear 21 closer to the one side Dab and the other side Daf than the drive gear main body 211.

A pair of the intermediate gear bearings 272 are fixed to the gear case 20. The intermediate gear bearing 272 is a radial bearing rotatably supporting the intermediate support shaft 240 of the intermediate gear 24 closer to the one side Dab and the other side Daf than the intermediate gear main body 241.

The pinion support shaft bearing 273 is fixed to the gear case 20. The pinion support shaft bearing 273 is a radial bearing rotatably supporting the second intermediate side pinion support shaft 260 of the second intermediate side pinion 26 closer to the one side Dab than the second intermediate side pinion main body 261.

The first compression unit bearing 274 is fixed to the gear case 20. The first compression unit bearing 274 is a radial bearing rotatably supporting the first rotating shaft 310a of the first rotor 310 in the first compression unit 31. The first compression unit bearing 274 is disposed closer to the one side Dab than the first drive side pinion main body 221 of the first drive side pinion 22.

The second compression unit bearing 275 is fixed to the gear case 20. The second compression unit bearing 275 is a radial bearing rotatably supporting closer to the one side Dab than the first intermediate side pinion main body 251 of the first intermediate side pinion 25. The second compression unit bearing 275 is disposed closer to the one side Dab than the first intermediate side pinion main body 251 of the first intermediate side pinion 25.

The third compression unit bearing 276 is fixed to the gear case 20. The third compression unit bearing 276 is a radial bearing rotatably supporting the third rotating shaft 330a of the third rotor 330 in the third compression unit 33. The third compression unit bearing 276 is disposed closer to the one side Dab than the second drive side pinion main body 231 of the second drive side pinion 23.

The fourth compression unit bearing 277 is fixed to the gear case 20. The fourth compression unit bearing 277 is a radial bearing rotatably supporting the fourth rotating shaft 340a of the fourth rotor 340 in the fourth compression unit 34. The fourth compression unit bearing 277 is disposed closer to the other side Daf than the first intermediate side pinion main body 251 of the first intermediate side pinion 25.

The fifth compression unit bearing 278 is fixed to the gear case 20. The fifth compression unit bearing 278 is a radial bearing rotatably supporting the fifth rotating shaft 350a of the fifth rotor 350 in the fifth compression unit 35. The fifth compression unit bearing 278 is disposed closer to the other side Daf than the first drive side pinion main body 221 of the first drive side pinion 22.

The sixth compression unit bearing 279 is fixed to the gear case 20. The sixth compression unit bearing 279 is a radial bearing rotatably supporting the sixth rotating shaft 360a of the sixth rotor 360 in the sixth compression unit 36. The sixth compression unit bearing 279 is disposed closer to the other side Daf than the second drive side pinion main body 231 of the second drive side pinion 23.

(Action and Effect)

In the integrally geared compressor 100 according to the above embodiment, the uniaxial multi-stage compressor 4 having the plurality of compressor impellers 40b is used. Accordingly, the compression efficiency of the integrally geared compressor 100 can be improved as compared with another compression unit 3 compressing with one impeller. As a result, the output of the integrally geared compressor 100 can be improved.

In addition, the drive gear 21 and the second intermediate side pinion 26 are connected via one intermediate gear 24. Accordingly, on condition that the gear diameters of the drive gear 21 and the second intermediate side pinion 26 are not changed, the relationship between the rotational speed of the drive gear 21 and the rotational speed of the second intermediate side pinion 26 can be maintained constant no matter how the gear diameter of the intermediate gear 24 is changed.

As a result, it is possible to dispose the uniaxial multi-stage compressor 4 at any position, without reducing the rotational speed of the uniaxial multi-stage compressor 4, simply by changing the gear diameter of the intermediate gear 24. Further, the relationship between the rotational speed of the drive gear 21 and the rotational speed of the second intermediate side pinion 26 is maintained constant. Accordingly, it is possible to suppress a gear-attributable loss when the uniaxial multi-stage compressor 4 is driven by the drive gear 21.

In addition, there is no need to dispose a new intermediate gear for driving the uniaxial multi-stage compressor 4 so as to mesh with the drive gear 21 or the intermediate gear 24. In other words, there is no need to add a new intermediate gear. In other words, it is possible to suppress an increase in dimension in the in-plane direction Pi as compared with a configuration in which an intermediate gear for the uniaxial multi-stage compressor 4 is added. Accordingly, it is possible to suppress an increase in the occupied space of the integrally geared compressor 100.

In addition, the uniaxial multi-stage compressor 4 having the plurality of compressor impellers 40b is larger in size than the compression unit 3 configured by one impeller. In a case where the second intermediate side pinion 26 to which the uniaxial multi-stage compressor 4 is connected is configured to directly mesh with the drive gear 21, the motor 1 for rotating the drive gear 21 and the uniaxial multi-stage compressor 4 interfere with each other. However, it is possible to suppress the interference between the motor 1 and the uniaxial multi-stage compressor 4 via the intermediate gear 24. Further, the size of the integrally geared compressor 100 can be reduced as compared with a case where every compression unit 3 is a uniaxial multi-stage compressor.

In addition, in the integrally geared compressor 100 according to the above embodiment, the first drive side pinion 22, the first intermediate side pinion 25, and the second intermediate side pinion 26 are smaller in outer diameter than the drive gear 21. As a result, the first drive side pinion 22, the first intermediate side pinion 25, and the second intermediate side pinion 26 are smaller in number of teeth than the drive gear 21. Accordingly, the first drive side pinion 22, the first intermediate side pinion 25, and the second intermediate side pinion 26 are higher in rotation speed than the drive gear 21.

In other words, the first compression unit 31 connected to the first drive side pinion 22, the second compression unit 32 connected to the first intermediate side pinion 25, and the uniaxial multi-stage compressor 4 connected to the second intermediate side pinion 26 are higher in rotation speed than the drive gear 21. Accordingly, the output of the integrally geared compressor 100 can be improved.

Further, the dimension in the in-plane direction Pi can be reduced as compared with a configuration in which the first drive side pinion 22, the first intermediate side pinion 25, and the second intermediate side pinion 26 are equal to or larger than the drive gear 21 in outer diameter. Accordingly, it is possible to further suppress an increase in occupied space while further improving the output of the integrally geared compressor 100.

In addition, in the integrally geared compressor 100 according to the above embodiment, the second compression unit 32 is configured to compress the working fluid G in a stage ahead of the first compression unit 31. Here, in order to further compress the working fluid G compressed by the second compression unit 32 by rotation, the first impeller 310b in the first compression unit 31 needs to be smaller than the second impeller 320b in the second compression unit 32 in a stage ahead of the first compression unit 31. In other words, the second impeller 320b in the second compression unit 32 needs to be larger than the first impeller 310b in the first compression unit 31.

According to the above configuration, the first intermediate side pinion 25 to which the second compression unit 32 having the second impeller 320b larger than the first impeller 310b in the first compression unit 31 is connected meshes with the intermediate gear 24. Accordingly, it is possible to avoid the second compression unit 32 interfering with the first compression unit 31 and the motor 1 as compared with, for example, a configuration in which the first intermediate side pinion 25 meshes with the drive gear 21.

In addition, in the integrally geared compressor 100 according to the above embodiment, the motor 1 and the uniaxial multi-stage compressor 4 are configured to be placed on the foundation B with the intermediate gear 24 meshing with the drive gear 21 in the drive gear upper half portion 211a of the drive gear 21 and the second intermediate side pinion 26 meshing with the intermediate gear 24 in the intermediate gear lower half portion 241b of the intermediate gear 24. As a result, the dimension in the in-plane direction Pi can be reduced as compared with, for example, a configuration in which the drive gear 21, the intermediate gear 24, and the second intermediate side pinion 26 mesh so as to be lined up in a row. Accordingly, the integrally geared compressor 100 can be made compact.

In addition, the uniaxial multi-stage compressor 4 is disposed on the foundation B where the motor 1 is placed at a lower position as compared with, for example, a configuration in which the second intermediate side pinion 26 meshes with the intermediate gear upper half portion 241a of the intermediate gear 24. Accordingly, the uniaxial multi-stage compressor 4 can be stably driven.

In addition, in the integrally geared compressor 100 according to the above embodiment, the shaft joint 5 connects the second intermediate side pinion support shaft 260 of the second intermediate side pinion 26 and the compressor rotating shaft 40a of the uniaxial multi-stage compressor 4. As a result, even in a case where misalignment occurs between the second intermediate side pinion support shaft 260 and the compressor rotating shaft 40a, the effect of the misalignment can be suppressed by the shaft joint 5. As a result, the rotor dynamics between the second intermediate side pinion support shaft 260 and the compressor rotating shaft 40a can be reduced.

Further, the rotor dynamics generated in the second intermediate side pinion support shaft 260 and the compressor rotating shaft 40a can be further reduced by the shaft joint 5 being elastically deformed. Accordingly, torque can be smoothly transmitted between the second intermediate side pinion support shaft 260 and the compressor rotating shaft 40a.

In addition, in the integrally geared compressor 100 according to the above embodiment, the third compression unit 33 connected to the second drive side pinion 23 meshing with the drive gear 21 compresses the working fluid Gin a stage behind the first compression unit 31 and ahead of the uniaxial multi-stage compressor 4. As a result, the third compression unit 33 further compresses the working fluid G compressed by the first compression unit 31. Accordingly, the pressure of the working fluid G is further increased. Accordingly, the output of the integrally geared compressor 100 can be further improved.

Further, the first intermediate side pinion 25 and the second intermediate side pinion 26 mesh with the intermediate gear 24. In addition, the first drive side pinion 22 and the second drive side pinion 23 mesh with the drive gear 21. In other words, many pinions do not mesh with only one of the drive gear 21 and the intermediate gear 24. As a result, it is possible to suppress the magnitude of the load applied to the teeth of each of the drive gear 21 and the intermediate gear 24 being biased.

### OTHER EMBODIMENTS

Although an embodiment of the present disclosure has been described in detail with reference to the drawings, the specific configuration is not limited to the configuration of the embodiment and additions, omissions, replacements, and other changes in configuration are possible without departing from the gist of the present disclosure. In addition, the present disclosure is not limited by the embodiment and is limited only by the claims.

It should be noted that the outer diameter of each pinion main body of the second drive side pinion 23, the first intermediate side pinion 25, and the second intermediate side pinion 26 (second drive side pinion main body 231, first intermediate side pinion main body 251, and second intermediate side pinion main body 261) may not be equal to the outer diameter of the first drive side pinion main body 221 of the first drive side pinion 22.

The outer diameters of the pinion main bodies of the first drive side pinion 22, the second drive side pinion 23, the first intermediate side pinion 25, and the second intermediate side pinion 26 (first drive side pinion main body 221, second drive side pinion main body 231, first intermediate side pinion main body 251, and second intermediate side pinion main body 261) may be mutually different.

In addition, the outer diameter of the intermediate gear main body 241 in the above embodiment may be equal to the outer diameter of the drive gear main body 211. In addition, the outer diameter of the intermediate gear main body 241 may be larger than the outer diameter of the drive gear main body 211. In addition, the outer diameter of the intermediate gear main body 241 may be smaller than the outer diameter of the drive gear main body 211.

In addition, the first intermediate side pinion main body 251 of the first intermediate side pinion 25 may mesh with the intermediate gear lower half portion 241b in the intermediate gear main body 241.

Further, although a configuration in which the working fluid G compressed by the second compression unit 32 is introduced into the fourth compression unit 34 has been described in the above embodiment, the present disclosure is not limited to this configuration. For example, in an alternative configuration, the working fluid G supplied from the outside may be simultaneously supplied to the second compression unit 32 and the fourth compression unit 34, be compressed by each of the second compression unit 32 and the fourth compression unit 34, and then merge to be introduced into the first compression unit 31. At this time, the outer diameter of the second impeller 320b in the second compression unit 32 and the outer diameter of the fourth impeller 340b in the fourth compression unit 34 may be equal to each other.

In addition, although a configuration in which the working fluid G supplied to the compression unit 3 is introduced in the order of the second compression unit 32, the fourth compression unit 34, the first compression unit 31, the fifth compression unit 35, the third compression unit 33, and the sixth compression unit 36 and sequentially compressed has been described in the above embodiment, the present disclosure is not limited to this configuration. The working fluid G may be introduced in any order with respect to the first compression unit 31, the second compression unit 32, the third compression unit 33, the fourth compression unit 34, the fifth compression unit 35, and the sixth compression unit 36. At this time, the size of the impeller in each compression unit 3 (first impeller 310b to sixth impeller 360b) may be smaller in the order in which the working fluid flows.

In addition, although a configuration in which the output axis O1 on the output shaft 10 and the drive axis O2 on the drive gear 21 are on the same straight line has been described in the above embodiment, the case of a slight deviation as well as the case of being completely on the same straight line is included.

In addition, although a configuration in which the second drive side pinion main body 231 meshes with the part of the drive gear main body 211 where the drive gear upper half portion 211a and the drive gear lower half portion 211b are switched has been described in the above embodiment, the present disclosure is not limited to this configuration. The second drive side pinion main body 231 may mesh with the drive gear upper half portion 211a in the drive gear main body 211. In addition, the second drive side pinion main body 231 may mesh with the drive gear lower half portion 211b in the drive gear main body 211.

In addition, although a configuration in which the outer diameter of each compressor impeller 40b in the uniaxial multi-stage compressor 4 is smaller than the outer diameter of the sixth impeller 360b in the sixth compression unit 36 has been described in the above embodiment, the present disclosure is not limited to this configuration. The outer diameter of each compressor impeller 40b in the uniaxial multi-stage compressor 4 may be larger than the outer diameter of the sixth impeller 360b in the sixth compression unit 36.

In addition, although a configuration in which the compressor rotor 40 of the uniaxial multi-stage compressor 4 has three compressor impellers 40b has been described in the above embodiment, the number is not limited to three.

In addition, the compressor casing 41 of the uniaxial multi-stage compressor 4 may be formed integrally with the gear case 20 of the compression unit drive mechanism 2.

In addition, the present disclosure is not limited to the configuration in which the shaft joint 5 is a diaphragm shaft joint. The shaft joint 5 may be, for example, a flange-shaped shaft joint, a gear-type shaft joint, a rubber shaft joint, a metal spring shaft joint, a roller chain shaft joint, or the like.

### Additional Notes

The integrally geared compressor described in the embodiment is, for example, grasped as follows.

(1) The integrally geared compressor 100 according to a first aspect includes: the drive gear 21 configured to rotate by the rotation of the motor 1; the intermediate gear 24 meshing with the drive gear 21; the first drive side pinion 22 meshing with the drive gear 21 at a position away from the intermediate gear 24; the first intermediate side pinion 25 meshing with the intermediate gear 24 at a position away from the drive gear 21; the second intermediate side pinion 26 meshing with the intermediate gear 24 at a position away from the drive gear 21 and the first intermediate side pinion 25; the first compression unit 31 connected to the first drive side pinion 22 and configured to compress the working fluid G supplied from the outside by the rotation of the first drive side pinion 22; the second compression unit 32 connected to the first intermediate side pinion 25 and configured to compress the working fluid G supplied from the outside by the rotation of the first intermediate side pinion 25; and the uniaxial multi-stage compressor 4 connected to the second intermediate side pinion 26 and configured to further compress the working fluid G compressed by at least one of the first compression unit 31 and the second compression unit 32.

As a result, there is no need to add a new intermediate gear 24 for driving the uniaxial multi-stage compressor 4 to the drive gear 21 or the intermediate gear 24. Accordingly, it is possible to suppress an increase in the dimension of the integrally geared compressor 100 as compared with a configuration in which the intermediate gear 24 for the uniaxial multi-stage compressor 4 is added.

(2) In the integrally geared compressor 100 according to a second aspect, which is the integrally geared compressor 100 of (1), the first drive side pinion 22, the first intermediate side pinion 25, and the second intermediate side pinion 26 may be smaller in outer diameter than the drive gear 21.

As a result, the number of teeth of each of the first drive side pinion 22, the first intermediate side pinion 25, and the second intermediate side pinion 26 is smaller than the number of teeth of the drive gear 21, and thus the first drive side pinion 22, the first intermediate side pinion 25, and the second intermediate side pinion 26 are higher in rotation speed than the drive gear 21. Accordingly, the first compression unit 31, the second compression unit 32, and the uniaxial multi-stage compressor 4 are capable of being higher in rotation speed than the drive gear 21.

(3) In the integrally geared compressor 100 according to a third aspect, which is the integrally geared compressor 100 of (1) or (2), the second compression unit 32 may is configured to compress the working fluid G in a stage ahead of the first compression unit 31.

In order to further compress the working fluid G compressed by the second compression unit 32 by rotation, the second compression unit 32 needs to be larger than the first compression unit 31. With the above configuration, it is possible to avoid the second compression unit 32 larger than the first compression unit 31 interfering with the first compression unit 31 and the motor 1 as compared with a configuration in which the first intermediate side pinion 25 to which the second compression unit 32 is connected meshes with the drive gear 21.

(4) In the integrally geared compressor 100 according to a fourth aspect, which is the integrally geared compressor 100 of any one of (1) to (3), the intermediate gear 24 may mesh with the drive gear 21 in the upper half portion of the drive gear 21 (drive gear upper half portion 211a), the second intermediate side pinion 26 may mesh with the intermediate gear 24 in the lower half portion of the intermediate gear 24 (intermediate gear lower half portion 241b), and the motor 1 and the uniaxial multi-stage compressor 4 may be placed on the foundation B positioned below the drive gear 21 and the intermediate gear 24 (lower side in the vertical direction).

As a result, the integrally geared compressor 100 can be made compact as compared with a configuration in which the drive gear 21, the intermediate gear 24, and the second intermediate side pinion 26 mesh so as to be lined up in a row. In addition, the uniaxial multi-stage compressor 4 is disposed on the foundation B where the motor 1 is placed at a lower position as compared with a configuration in which the second intermediate side pinion 26 meshes with the upper half portion of the intermediate gear 24 (intermediate gear upper half portion 241a). Accordingly, the uniaxial multi-stage compressor 4 can be stably driven.

(5) The integrally geared compressor 100 according to a fifth aspect, which is the integrally geared compressor 100 of (4), may further include the shaft joint 5 connecting the pinion support shaft of the second intermediate side pinion 26 (second intermediate side pinion support shaft 260) and the compressor rotating shaft 40a of the uniaxial multi-stage compressor 4.

As a result, even in a case where misalignment occurs between the second intermediate side pinion support shaft 260 and the compressor rotating shaft 40a, the rotor dynamics generated in the second intermediate side pinion support shaft 260 and the compressor rotating shaft 40a can be reduced by the shaft joint 5.

(6) The integrally geared compressor 100 according to a sixth aspect, which is the integrally geared compressor 100 of any one of (1) to (5), may further include: the second drive side pinion 23 meshing with the drive gear 21 at a position away from the intermediate gear 24; and the third compression unit 33 connected to the second drive side pinion 23 and compressing the working fluid G by the rotation of the second drive side pinion 23, in which the third compression unit 33 may is configured to compress the working fluid Gin a stage behind the first compression unit 31 and ahead of the uniaxial multi-stage compressor 4.

As a result, the working fluid G compressed by the first compression unit 31 is further compressed by the third compression unit 33, and thus the output of the integrally geared compressor 100 can be further improved. In addition, it is possible to suppress the magnitude of the load applied to the teeth of each of the drive gear 21 and the intermediate gear 24 being biased.

### EXPLANATION OF REFERENCES

1: motor
2: compression unit drive mechanism
3: compression unit
4: uniaxial multi-stage compressor
5: shaft joint
10: output shaft
11: motor main body
20: gear case
21: drive gear
22: first drive side pinion
23: second drive side pinion
24: intermediate gear
25: first intermediate side pinion
26: second intermediate side pinion
27: bearing
31: first compression unit
32: second compression unit
33: third compression unit
34: fourth compression unit
35: fifth compression unit
36: sixth compression unit
40: compressor rotor
40a: compressor rotating shaft
40b: compressor impeller
41: compressor casing
41a: casing main body
41b: suction port
41c: discharge port
100: integrally geared compressor
210: drive support shaft
211: drive gear main body
211a: drive gear upper half portion
211b: drive gear lower half portion
220: first drive side pinion support shaft
221: first drive side pinion main body
222: first thrust bearing
230: second drive side pinion support shaft
231: second drive side pinion main body
232: second thrust bearing
240: intermediate support shaft
241: intermediate gear main body
241a: intermediate gear upper half portion
241b: intermediate gear lower half portion
250: first intermediate side pinion support shaft
251: first intermediate side pinion main body
252: third thrust bearing
260: second intermediate side pinion support shaft
261: second intermediate side pinion main body
262: fourth thrust bearing
271: drive gear bearing
272: intermediate gear bearing
273: pinion support shaft bearing
274: first compression unit bearing
275: second compression unit bearing
276: third compression unit bearing
277: fourth compression unit bearing
278: fifth compression unit bearing
279: sixth compression unit bearing
310: first rotor
310a: first rotating shaft
310b: first impeller
311: first compression unit casing
311a: first gas introduction port
311b: first gas discharge port
320: second rotor
320a: second rotating shaft
320b: second impeller
321: second compression unit casing
321a: second gas introduction port
321b: second gas discharge port
330: third rotor
330a: third rotating shaft
330b: third impeller
331: third compression unit casing
331a: third gas introduction port
331b: third gas discharge port
340: fourth rotor
340a: fourth rotating shaft
340b: fourth impeller
341: fourth compression unit casing
341a: fourth gas introduction port
341b: fourth gas discharge port
350: fifth rotor
350a: fifth rotating shaft
350b: fifth impeller
351: fifth compression unit casing
351a: fifth gas introduction port
351b: fifth gas discharge port
360: sixth rotor
360a: sixth rotating shaft
360b: sixth impeller
361: sixth compression unit casing
361a: sixth gas introduction port
361b: sixth gas discharge port
A1: first axis
A2: second axis
A3: third axis
A4: fourth axis
B: foundation
C: coupling
Da: axial direction
Dab: one side
Daf: the other side
G: working fluid
O: axis
O1: output axis
O2: drive axis
O3: intermediate axis
Pi: in-plane direction
Po: out-of-plane direction
X: virtual surface

What is claimed is:

1. An integrally geared compressor comprising:
a drive gear configured to rotate by rotation of a motor;
an intermediate gear meshing with the drive gear;
a first drive side pinion meshing with the drive gear at a position away from the intermediate gear;
a first intermediate side pinion meshing with the intermediate gear at a position away from the drive gear;
a second intermediate side pinion meshing with the intermediate gear at a position away from the drive gear and the first intermediate side pinion;
a first compression unit connected to the first drive side pinion and configured to compress a working fluid supplied from an outside by rotation of the first drive side pinion;
a second compression unit connected to the first intermediate side pinion and configured to compress a working fluid supplied from an outside by rotation of the first intermediate side pinion; and
a uniaxial multi-stage compressor connected to the second intermediate side pinion and configured to further compress the working fluid compressed by at least one of the first compression unit and the second compression unit.

2. The integrally geared compressor according to claim 1,
wherein the first drive side pinion, the first intermediate side pinion, and the second intermediate side pinion are smaller in outer diameter than the drive gear.

3. The integrally geared compressor according to claim 1,
wherein the second compression unit is configured to compress the working fluid in a stage ahead of the first compression unit.

4. The integrally geared compressor according to claim 1,
wherein the intermediate gear meshes with the drive gear in an upper half portion of the drive gear,
the second intermediate side pinion meshes with the intermediate gear in a lower half portion of the intermediate gear, and
the motor and the uniaxial multi-stage compressor are placed on a foundation positioned below the drive gear and the intermediate gear.

5. The integrally geared compressor according to claim 4, further comprising a shaft joint connecting a pinion support shaft of the second intermediate side pinion and a compressor rotating shaft of the uniaxial multi-stage compressor.

6. The integrally geared compressor according to claim 1, further comprising:
a second drive side pinion meshing with the drive gear at a position away from the intermediate gear; and
a third compression unit connected to the second drive side pinion and compressing the working fluid by rotation of the second drive side pinion,
wherein the third compression unit is configured to compress the working fluid in a stage behind the first compression unit and ahead of the uniaxial multi-stage compressor.
